(19) United States
(12) Patent Application Publication
(10) Pub. No.: US 2014/0139478 A1
(43) Pub. Date: May 22, 2014

(54) TOUCH SENSING METHOD AND TOUCH SENSING DEVICE

(71) Applicant: SAMSUNG ELECTRO-MECHANICS CO., LTD., Suwon (KR)

(72) Inventors: Hyun Suk Lee, Suwon (KR); Tah Joon Park, Suwon (KR); Kang Joo Kim, Suwon (KR)

(73) Assignee: SAMSUNG ELECTRO-MECHANICS CO., LTD., Suwon (KR)

(21) Appl. No.: 13/764,042

(22) Filed: Feb. 11, 2013

(30) Foreign Application Priority Data
Nov. 22, 2012 (KR) 10-2012-0132967

(51) Int. Cl. G06F 3/044

(52) U.S. Cl. CPC G06F 3/044
USPC 345/174; 345/173

(57) ABSTRACT

There are provided a touch sensing method and a touch sensing device. The touch sensing method includes: obtaining sensed data from a panel unit; calculating valid data by removing an offset value from the sensed data; calculating reference data by comparing the offset value with a backup offset value when the valid data is higher than a first reference value; and determining a touch based on the reference data and the valid data.

### CROSS-REFERENCE TO RELATED APPLICATIONS

This application claims the priority of Korean Patent Application No. 10-2012-0132967 filed on Nov. 22, 2012, in the Korean Intellectual Property Office, the disclosure of which is incorporated herein by reference.

### BACKGROUND OF THE INVENTION

1. Field of the Invention

The present invention relates to a touch sensing method and a touch sensing device capable of accurately determining a touch according to an offset value optimized for a panel unit environment by considering an influence of foreign objects, such as droplets of water, present on a panel unit and preventing an offset value from being erroneously updated during a user operation of removing the foreign objects in calculating an offset value as a reference for determining a touch.

2. Description of the Related Art

A touch sensing device such as a touch screen, a touch pad, or the like, is an input device attached to a display device to provide an intuitive input method to a user. Recently, a touch sensing device has been widely applied to various electronic devices such as a portable phone, a personal digital assistant (PDA), a navigation device, and the like. In particular, recently, as demand for smartphones has increased, an uptake rate of touch screens as touch sensing devices capable of providing various input methods in a limited area has increased.

Touch screens employed in portable devices may be classified as a resistive touch screen or a capacitive touch screen, according to a method of sensing a touch utilized thereby. Here, the capacitive touch screen, having advantages in that it has a relatively long lifespan and allows for various user input methods and gestures, has been increasingly employed. In particular, the capacitive touch screen, facilitating the use of a multi-touch interface, unlike in the case of the resistive touch screen, is extensively employed in devices such as smartphones, and the like.

The capacitive touch screen includes a plurality of electrodes having a predetermined pattern, and a plurality of nodes in which capacitance is changed by a touch are defined by the plurality of electrodes. The plurality of nodes distributed on a two-dimensional (2D) plane generate a change in self-capacitance or mutual-capacitance according to a user's touch, and coordinates of a touch may be calculated by applying a weighted average calculation method, or the like, to the change in capacitance generated in the plurality of nodes. In order to accurately calculate coordinates of a touch, an offset value, used as a reference for determining a touch, should be continuously updated according to an operating environment, and when an offset value is erroneously updated by foreign objects present on a panel unit, an unintentional touch, or the like, may be recognized, while a touch actually intended by the user may not be recognized.

Patent Document 1 relates to a touch screen in which a noise level, rather than a reference value or an offset value for determining a touch from sensed data, is directly sensed and a sequence in which a driving signal is applied is adjusted based on the sensed noise level. Patent Document 2 also relates to a touch screen in which an error is corrected according to whether a sensed data value exceeds an input range of an analog-to-digital converter. However, neither of cited references 1 and 2 disclose a technique in which an offset value for determining a touch is updated according to an operating environment of a panel unit or a touch error is determined by comparing a backup offset value with a current offset value, or the like.

### RELATED ART DOCUMENT

(Patent Document 1) Korean Patent Laid-Open Publication No. 10-2012-0017887

(Patent Document 2) Japanese Patent Laid-Open Publication No. 2011-198367

### SUMMARY OF THE INVENTION

An aspect of the present invention provides a touch sensing method and a touch sensing device capable of comparing valid data obtained by removing an offset value from sensed data with a predetermined reference value and determining a touch based on the comparison result. In particular, a comparison result obtained by comparing a current offset value with a backup offset value is calculated together with valid data, and a touch error and a foreign object present on a panel unit are determined based on the calculation result, whereby accurate touch coordinates may be provided.

According to an aspect of the present invention, there is provided a touch sensing method including: obtaining sensed data from a panel unit; calculating valid data by removing an offset value from the sensed data; calculating reference data by comparing the offset value with a backup offset value when the valid data is higher than a first reference value; and determining a touch based on the reference data and the valid data.

The determining of the touch may include: calculating a comparison value indicating a relationship between the reference data and the valid data; and determining the sensed data as being generated by removal of a foreign object in contact with the panel unit when the comparison value is higher than a second reference value, and updating the offset value to a different value.

The determining of the touch may include calculating at least one of coordinates, number and gesture of the touch based on the valid data when the comparison value is lower than the second reference value.

The calculating of the comparison value may include using at least one of a correlation, a mean square error (MSE), and a maximum error between the reference data and the valid data as the comparison value.

The touch sensing method may further include updating the offset value when the valid data is lower than the first reference value.

The touch sensing method may further include storing the offset value as the backup offset value before updating the offset value when the valid data has a negative (−) value.

The obtaining of the sensed data may be performed based on a change in capacitance generated in a plurality of nodes included in the panel unit.

According to another aspect of the present invention, there is provided a touch sensing device including: a memory unit; a valid data calculation unit calculating valid data by subtracting an offset value obtained from the memory unit from sensed data obtained from a panel unit; and a control unit calculating reference data by comparing the offset value with a predetermined backup offset value when the valid data is higher than a first reference value, and determining a touch based on the reference data and the valid data.

The control unit may calculate a comparison value indicating a relationship between the reference data and the valid data, determine the sensed data as being generated by removal of a foreign object in contact with the panel unit when the comparison value is higher than a second reference value, and update the offset value to a different value.

The control unit may determine the touch based on the valid data when the comparison value is lower than the second reference value.

The control unit may calculate at least one of a correlation, a mean square error (MSE), and a maximum error between the reference data and the valid data as the comparison value.

The control unit may update the offset value to a different value when the valid data is lower than the first reference value.

The control unit may backs up the offset value to the memory unit before updating the offset value when the valid data has a negative (−) value.

The touch sensing device may further include: a driving circuit unit applying a predetermined driving signal to at least a portion of a plurality of nodes included in the panel unit; and a sensing circuit unit obtaining the sensed data from the at least a portion of a plurality of nodes to which the driving signal has been applied.

According to another aspect of the present invention, there is provided a touch sensing device including: a plurality of first electrodes extending in a first axial direction; a plurality of second electrodes extending in a second axial direction intersecting the first axial direction; and a controller integrated circuit (IC) detecting changes in capacitance generated between the plurality of first electrodes and the plurality of second electrodes, wherein the controller IC obtains valid data by subtracting an offset value from sensed data generated by the changes in capacitance, and calculates reference data by comparing the offset value with a backup offset value when the valid data is higher than a first reference value, and the controller IC determines the sensed data as being generated by removal of a foreign object when a value indicating a relationship between the valid data and the reference data is higher than a predetermined second reference value.

The controller IC may determine the touch based on the valid data when the value indicating the relationship between the valid data and the reference data is lower than the second reference value.

The controller IC may update the offset value to a different value when the value indicating the relationship between the valid data and the reference data is higher than the second reference value.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the exterior of an electronic device including a touch sensing device according to an embodiment of the present invention;

FIG. 2 is a view illustrating a panel unit that may be included in a touch sensing device according to an embodiment of the present invention;

FIG. 3 is a circuit diagram of a touch sensing device according to an embodiment of the present invention;

FIG. 4 is a flowchart illustrating a touch sensing method according to an embodiment of the present invention;

FIG. 5 is a block diagram of a touch sensing device according to an embodiment of the present invention; and

FIGS. 6 and 7 are graphs showing operations of a touch sensing device according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same or like reference numerals will be used to designate the same or like elements.

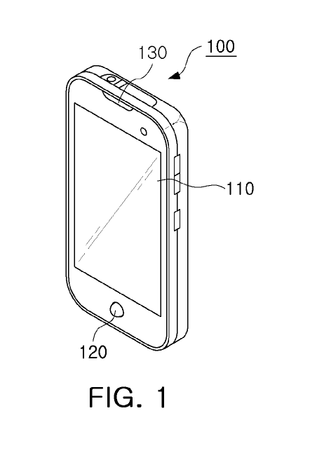

FIG. 1 is a perspective view illustrating the exterior of an electronic device including a touch sensing device according to an embodiment of the present invention.

Referring to FIG. 1, an electronic device 100 according to the embodiment of the present embodiment may include a display unit 110 for outputting an image, an input unit 120, an audio output unit 130 for outputting a voice, and the like, and also, a touch sensing device which is integrated with the display unit 110.

As illustrated in FIG. 1, in the case of the mobile device, in general, a touch sensing device is integrated with the display unit, and the touch sensing device is required to have as high a degree of light transmittance as possible so as to allow an image displayed on the display unit to be transmitted therethrough. Thus, the touch sensing device may be implemented by forming sensing electrodes with a material such as indium tin oxide (ITO), indium zinc oxide (IZO), zinc oxide (ZnO), carbon nano-tubes (CNTs), or graphene having electrical conductivity on a base substrate made of a transparent film material such as polyethylene terephthalate (PET), polycarbonate (PC), polyethersulfone (PES), polyimide (PI), or the like. A wiring pattern connected to the sensing electrodes made of a transparent conductive material is disposed in a bezel region of the display unit. Since the wiring pattern is visually shielded by the bezel region, the wiring pattern may be made of a metal such as silver (Ag), copper (Cu), or the like.

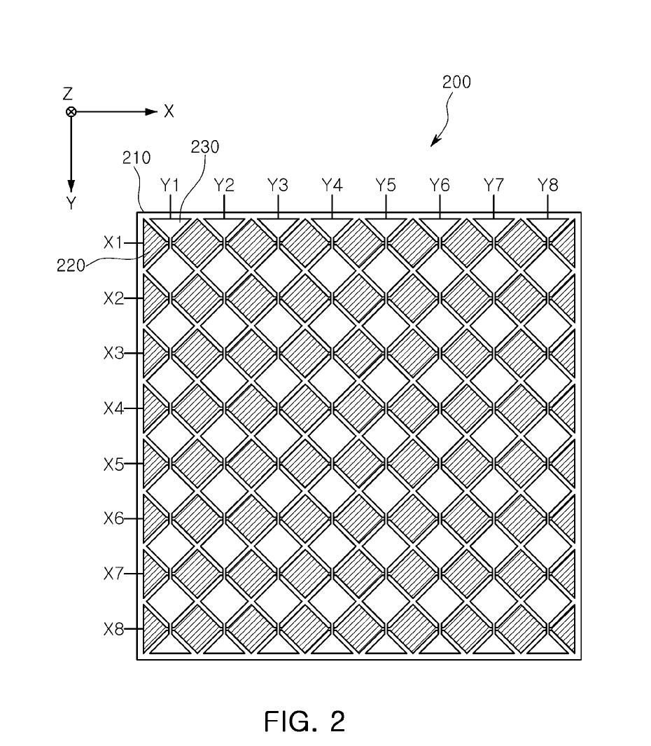

The touch sensing device according to the embodiment of the present invention operates according to a capacitive scheme, so it may include a plurality of electrodes having a predetermined pattern. Also, the touch sensing device according to the embodiment of the present invention may include a capacitance detection circuit detecting a change in capacitance generated by the plurality of electrodes, an analog-to-digital conversion circuit converting an output signal from the capacitance detection circuit into a digital value, a calculation circuit determining a touch by using data which has been converted into the digital value, and the like. Hereinafter, the touch sensing device and an operating method thereof according to an embodiment of the present invention will be described with reference to FIGS. 2 through 7.

FIG. 2 is a view illustrating a touch screen panel unit that may be included in a touch sensing device according to an embodiment of the present invention.

Referring to FIG. 2, a panel screen 200 according to the present embodiment includes a substrate 210 and a plurality of sensing electrodes 220 and 230 provided thereon. Although not shown, the plurality of sensing electrodes 220 and 230 may be electrically connected to a wiring pattern of a circuit board attached to one end of the substrate 210 through a wiring and a bonding pad. A controller integrated circuit (IC) may be mounted on the circuit board to detect sensing signals generated by the plurality of sensing electrodes 220 and 230 and determine a touch from the sensing signals.

In the case of the touch screen device, the substrate 210 may be a transparent substrate on which the sensing electrodes 220 and 230 are formed, and may be made of a plastic material such as polyimide (PI), polymethylmethacrylate (PMMA), polyethyleneterephthalate (PET), or polycarbonate (PC), or tempered glass. Aside from a region in which the sensing electrodes 220 and 230 are formed, a predetermined printed region for visually shielding a wiring generally made of an opaque metal may be formed on the substrate 210 with respect to a region in which the wiring connected to the sensing electrodes 220 and 230 is provided.

The plurality of sensing electrodes 220 and 230 may be formed on one surface of the substrate 210 or on both surfaces thereof. The touch screen device may be made of ITO, IZO, ZnO, CNT, a graphene material, or the like, which is transparent and has conductivity. In FIG. 2, the sensing electrodes 220 and 230 having a diamond-like pattern are illustrated, but the present invention is not limited thereto and the sensing electrodes 220 and 230 may also have various polygonal patterns such as a rectangular pattern, a triangular pattern, or the like.

The plurality of sensing electrodes 220 and 230 include first electrodes 220 extending in an X-axial direction and second electrodes 230 extending in a Y-axial direction. The first electrodes 220 and the second electrodes 230 may be formed on both surfaces of the substrate 210 or may be alternately formed on different substrates 210. In the case that both the first electrodes 220 and the second electrodes 230 are formed on one surface of the substrate 210, a predetermined insulating layer may be partially formed in intersections of the first electrodes 220 and the second electrodes 230.

The touch sensing device, electrically connected to the plurality of sensing electrodes 220 and 230 to sense a touch, may detect a change in capacitance generated from the plurality of sensing electrodes 220 and 230 according to a touch applied thereto and sense the touch based on the detected change in capacitance. The first electrodes 220 may be connected to channels defined as D1 to D8 in the controller IC to receive a predetermined driving signal, and the second electrode 230 may be connected to channels defined as S1 to S8 so as to be used for the touch sensing device to detect a sensing signal. Here, the controller IC may detect a change in mutual capacitance generated between the first electrodes 220 and the second electrodes 230, as a sensing signal, and operate to sequentially apply a driving signal to the respective first electrodes 220 and simultaneously detect a change in capacitance in the second electrodes 230. Namely, when M number of first electrodes 220 and N number of second electrodes 230 are provided, the controller IC may detect M×N number of capacitance change data for determining a touch.

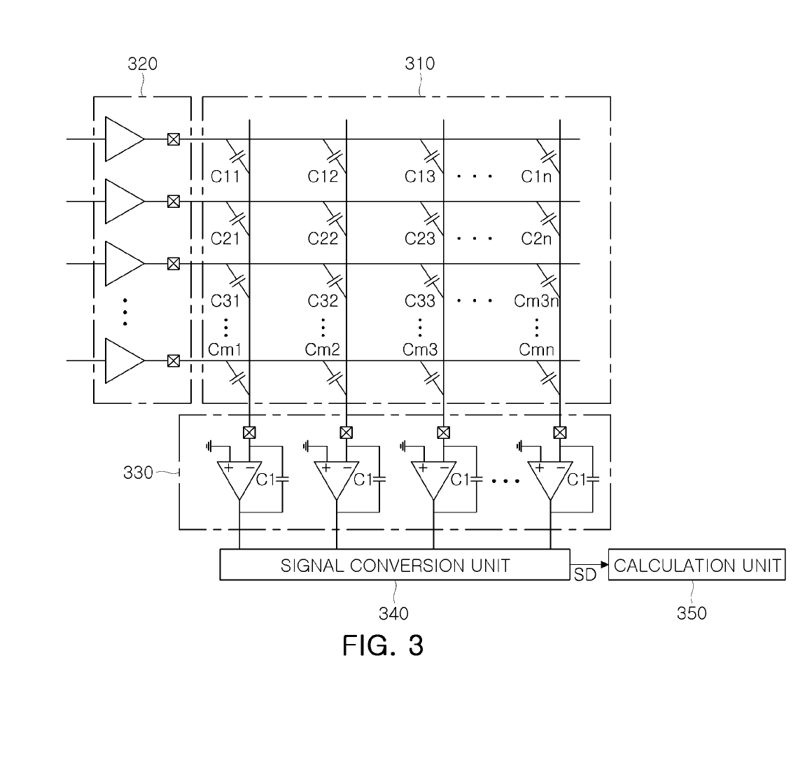

FIG. 3 is a circuit diagram of a touch sensing device according to an embodiment of the present invention.

Referring to FIG. 3, the touch sensing device according to the embodiment of the present invention includes a panel unit 310, a driving circuit unit 320, a sensing circuit unit 330, a signal conversion unit 340, and a calculation unit 350. The panel unit 310 includes m number of first electrodes extending in a first axial direction (or a horizontal direction in FIG. 3) and n number of second electrodes extending in a second axial direction (or a vertical direction in FIG. 3) intersecting the first axial direction. Changes in capacitance C11 to Cmn are generated in a plurality of nodes in which the first electrodes and the second electrodes intersect. The changes in capacitance C11 to Cmn generated in the plurality of nodes may be changes in mutual capacitance generated by a driving signal applied to the first electrodes by the driving circuit unit 320. Meanwhile, the driving circuit unit 320, the sensing circuit unit 330, the signal conversion unit 340, and the calculation unit 350 may be implemented as a single integrated circuit (IC).

The driving circuit unit 320 applies a predetermined driving signal to the first electrodes of the panel unit 310. The driving signal may have a square wave, a sine wave, a triangle wave, or the like, having a predetermined period and amplitude, and may be sequentially applied to the plurality of respective first electrodes. In FIG. 3, circuits for generating and applying driving signals are individually connected to the plurality of respective first electrodes, but the present invention is not limited thereto and it may be configured such that a single driving signal generation circuit is provided and a driving signal may be applied to a plurality of respective first electrodes by using a switching circuit. Also, the driving signal may be simultaneously applied to all the first electrodes or may be selectively applied to only some of the first electrodes to simply detect presence or absence of a touch.

The sensing circuit unit 330 may include an integrating circuit for sensing the changes in capacitance C11 to Cmn generated in the plurality of nodes. The integrating circuit may be connected to the plurality of second electrodes. The integrating circuit may include at least one operational amplifier and a capacitor C1 having a certain capacity. An inverting input terminal of the operational amplifier is connected to the second electrode to convert the changes in capacitance C11 to Cmn into an analog signal such as a voltage signal, or the like, and output the same. When the driving signal is sequentially applied to the plurality of respective first electrodes, the changes in capacitance may be simultaneously detected from the plurality of second electrodes, so n number of integrating circuits corresponding to n number of the second electrodes may be provided.

The signal conversion unit 340 generates a digital signal S_{D} from the analog signal generated by the integrating circuit. For example, the signal conversion unit 340 may include a time-to-digital converter (TDC) circuit measuring a time during which an analog signal in a voltage form output by the sensing circuit unit 330 reaches a predetermined reference voltage level and converting the same into a digital signal S_{D}, or may include an analog-to-digital converter (ADC) circuit measuring an amount by which a level of an analog signal output by the sensing circuit unit 330 changes for a predetermined time and converting the same into a digital signal S_{D}. The calculation unit 350 may determine a touch applied to the panel unit 310 by using the digital signal S_{D}. In the embodiment of the present invention, the calculation unit 350 may determine the number of touches applied to the panel unit 310, coordinates of the touches, gestures, or the like.

The digital signal S_{D} used as a reference for the calculation unit 350 to determine a touch may be data obtained by digitizing the changes in capacitance C11 to Cmn, and in particular, it may be data indicating a difference of capacitance between a case in which a touch has not been generated and a case in which a touch has been generated. In general, in a touch sensing device based on a capacitance scheme, a region in contact with a conductive object has reduced capacitance relative to a region having no contact therewith.

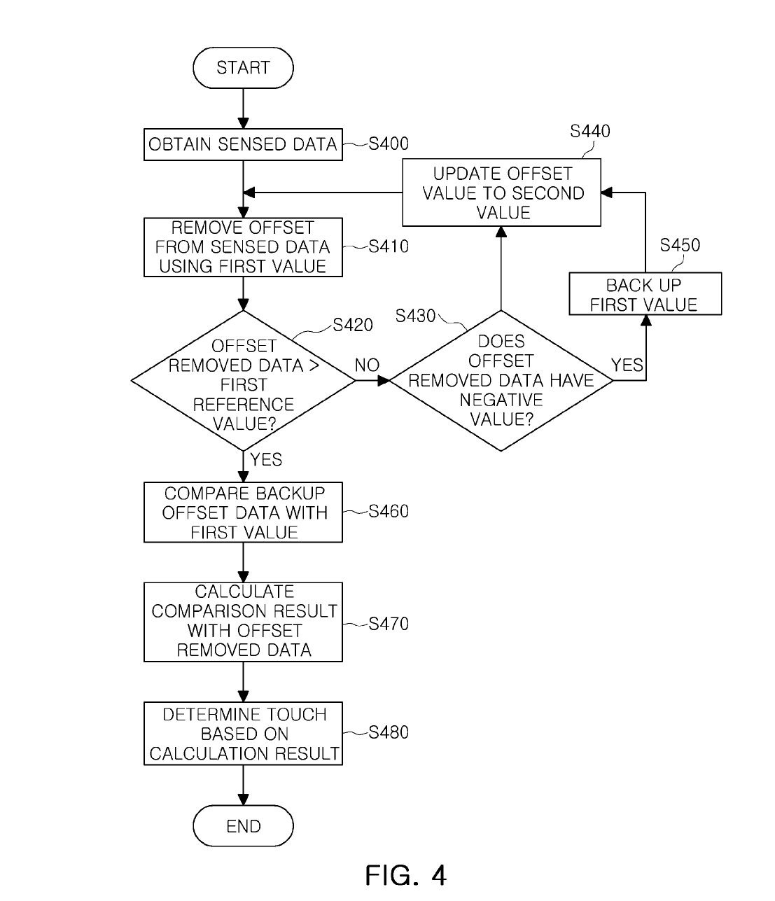

FIG. 4 is a flowchart illustrating a touch sensing method according to an embodiment of the present invention.

Referring to FIG. 4, a touch sensing method according to the present embodiment starts by obtaining sensed data from the panel unit 310 (S400). As described above, the driving circuit unit 320 may sequentially apply a driving signal to the plurality of first electrodes and the sensing circuit unit 330 may detect a change in capacitance from the plurality of second electrodes intersecting the first electrodes to which the driving signal has been applied. The sensing circuit unit 330 may detect a change in capacitance in the form of an analog signal by using an integrating circuit, and the analog signal output by the sensing circuit unit 330 is converted into a digital signal S_{D} by the signal conversion unit 340. The calculation unit 350 may determine a touch by using the digital signal S_{D} as sensed data.

When the sensed data is obtained, the calculation unit 350 subtracts a first value from the sensed data (S410). Here, the subtracted first value is applied as an offset value with respect to the sensed data. The calculation unit 350 may compare the offset-removed valid data with a first reference value and determine whether a valid touch has been generated, according to the comparison result (S420). Namely, the first reference value compared with the valid data by the calculation unit 350 is data corresponding to a threshold value of a change in capacitance appearing when a touch has been generated. When the valid data is determined to be lower than the first reference value in operation S420, it may be determined that a valid touch has not been generated on the panel unit 310.

When the valid data is lower than the first reference value in operation S420, the calculation unit 350 additionally determines whether the valid data has a negative (−) value (S430). When the valid data does not have a negative (−) value in operation S430, it is determined that an offset value has been changed due to electrical noise, or the like, and the offset value is updated to a second value different from the first value (S440).

Meanwhile, when the valid data has the negative (−) value, it may be determined that a foreign object such as droplets of water exists on the panel unit 310 and a portion of sensed data obtained from the panel unit 310 is higher than the offset value. Thus, the calculation unit 350 updates the offset value to the second value in order to recognize a user's touch operation of removing a foreign object such as droplets of water by discriminating it from a general touch operation intended to come into contact with a particular spot (S440) and backs up the first value, which has been applied to the currently obtained valid data as the offset value, to a memory unit (S450).

Meanwhile, when the valid data is higher than the first reference value in operation S420, the calculation unit 350 may determine that a touch has been generated in any form on the panel unit 310. In this case, a touch operation for removing droplets of water, or the like, present on the panel unit 310 and a general touch operation of the user are required to be recognized discriminately, so an offset value backed up to the memory unit is first retrieved and compared with the first value that is a current offset value (S460). The calculation unit 350 may calculate reference data for determining a touch error by subtracting the backup offset value from the first value that is the current offset value.

The calculation unit 350 calculates a value indicating a relationship between the reference data and the offset-removed valid data (S470). The calculation unit 350 may calculate at least one of a correlation, a mean square error (MSE), and a maximum error between the reference data and the valid data. By comparing the calculated result with a second reference value, the calculation unit 350 may determine whether the sensed data obtained in operation S400 has been generated by a general touch operation of the user or by an operation of removing a foreign object such as droplets of water, or the like, present on the panel unit 310 (S480).

In detail, the calculation unit 350 may compare the calculation result (which is assumed to be the MSE for convenience of explanation) obtained in operation S470 with the second reference value. The second reference value may be a reference value for determining a user's touch intention, and when the MSE value obtained in operation S470 is lower than the second reference value, the touch which has generated the sensed data in operation S400 may be determined as a general touch according to a user intention. Thus, when the MSE value is lower than the second reference value, the coordinates, number, and gesture of the touch may be determined according to a general image process based on the valid data obtained in operation S410.

Meanwhile, when the MSE value calculated in operation S470 is higher than the second reference value, the calculation unit 350 may determine the touch which has generated the sensed data in operation S400 as a touch for removing a foreign object such as droplets of water, or the like, present on the panel unit 310. Thus, without a touch determination such as coordinate calculation, the calculation unit 350 updates the offset value to a second value and terminates the procedure of determining a touch of a current cycle. Updating the offset value to the second value may be performed to apply an offset value determined according to an environment of the panel unit 310 without a foreign object such as droplets of water, or the like, to a touch of the next cycle.

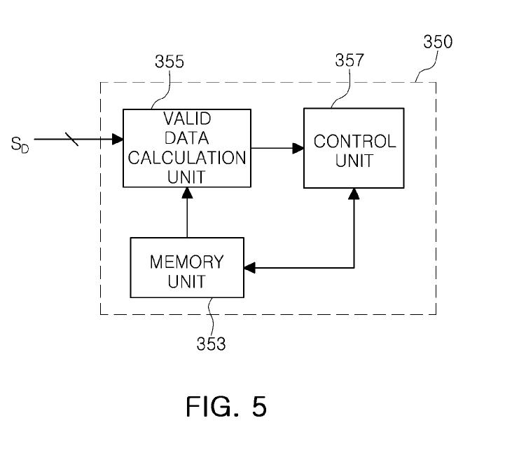

FIG. 5 is a block diagram of a touch sensing device according to an embodiment of the present invention.

FIG. 5 shows an internal configuration of the calculation unit 350 in the touch sensing device 300 according to the embodiment of the present invention. The calculation unit 350 may include a memory unit 353, a valid data calculation unit 355, a control unit 357, and the like. The memory unit 353 may store a plurality of data applied as offset values, and the valid data calculation unit 355 may produce valid data by subtracting a predetermined offset value stored in the memory unit 353 from the sensed data S_{D} in a digital form.

The control unit 357 performs a touch sensing method described above with reference to FIG. 4 by using the valid data and the data retrieved from the memory unit 353. Namely, the controller 357 may determine whether a touch has been generated by comparing the valid data with the first reference value, and then determine whether to perform offset updating or backup accordingly. Also, the control unit 357 may compare the reference data for determining a touch error with the valid data to determine whether the currently obtained sensed data has been generated by a general touch or by an operation for removing a foreign object such as droplets of water, or the like, from the panel unit 310.

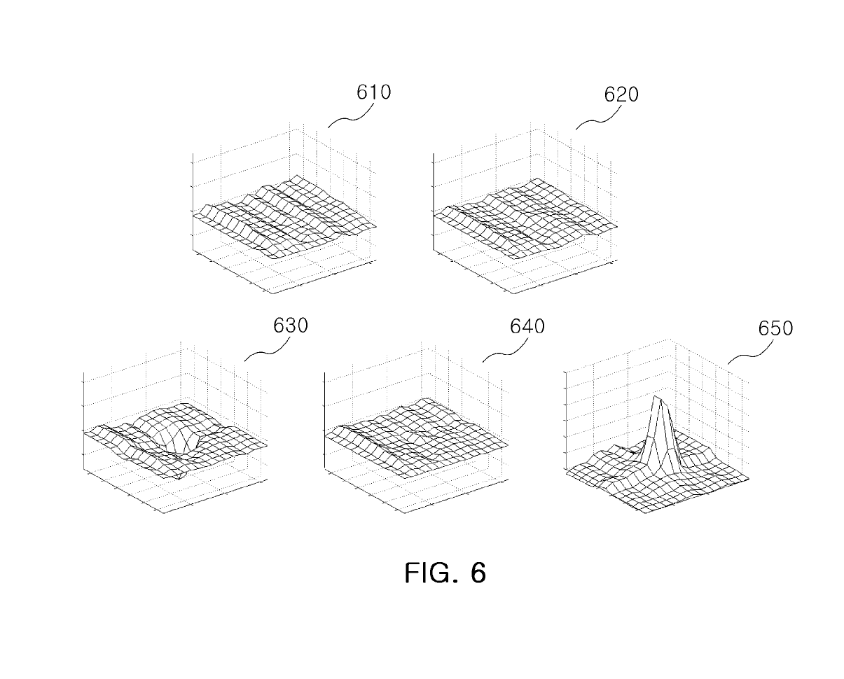

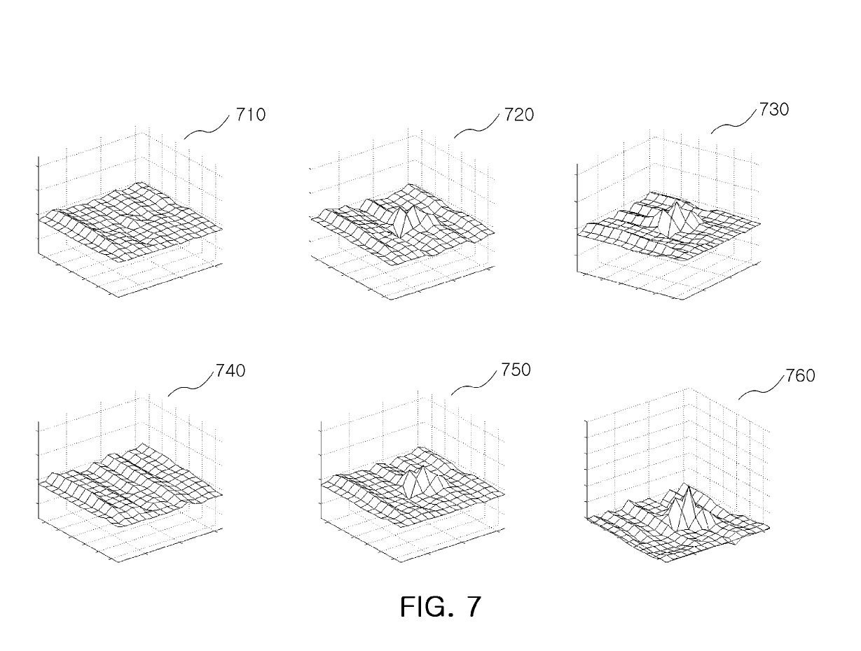

FIGS. 6 and 7 are graphs showing operations of a touch sensing device according to an embodiment of the present invention.

First, referring to FIG. 6, a first graph 610 and a second graph 620 represent sensed data and an offset value obtained from the panel unit 310 when a touch has not been generated. Namely, the first graph corresponding to sensed data has similar values throughout the entire region of the panel unit 310, similar to the second graph 620 corresponding to the offset.

Meanwhile, a third graph 630 represents sensed data when a touch is generated. It can be seen that the touch has been generated in the vicinity of a central region of the panel unit 310, and sensed data is reduced in a touch region because a change in capacitance is released to an object (i.e., a user's finger, or the like) from the nodes of the panel unit 310 adjacent to the region in which the touch has been generated. A fifth graph 650 representing valid data used to determine a touch by the calculation unit 350 is obtained by removing an offset value of a fourth graph 640 from the sensed data of the third graph 630 and taking a reciprocal number thereof.

FIG. 7 is graphs illustrating a process of removing a foreign object such as droplets of water, or the like, present on the panel unit 310. A first graph 710 represent offset data in a state in which there is no touch and there is no foreign object such as droplets of water, or the like. A second graph 720 represents sensed data obtained in a state in which a foreign object such as droplets of water, or the like, exists on the panel unit 310. Also, a third graph 730 is a graph corresponding to a reciprocal number of offset-removed data corresponding to a difference between the first graph 710 and the second graph 720. In the present embodiment, since the offset-removed data value itself has a negative (−) value before taking a reciprocal number, the offset data represented by the first graph 710 is backed up to the memory unit 353 and the data illustrated in the third graph 730 is updated to new offset data (S450 and S460 in FIG. 4).

A fourth graph 740 represents sensed data after performing an operation of removing a foreign object such as droplets of water, or the like. Since the sensed data is obtained after the foreign object was removed, the data having a peak shape illustrated in the second graph 720 disappeared. A fifth graph 750 is offset data applied to a process of determining a touch from the sensed data of the fourth graph 740, which is the same data as that of the third graph 730.

When the sensed data is obtained after the operation of removing the foreign object such as droplets of water, or the like, illustrated in the fourth graph 740, the calculation unit 350 calculates a difference value between the sensed data of the fourth graph 740 and the data of the fifth graph 750 corresponding to the current offset data. The calculation results correspond to the sixth graph 760.

Meanwhile, before determining a touch from the sixth graph 760, the calculation unit 350 compares the data of the sixth graph 760 with reference data that is a difference value between the current offset data represented by the third graph 730 and the backup offset data represented by the first graph 710. Referring to the graphs illustrated in FIG. 7, the reference data that is the difference value between the third graph 730 and the first graph 710 may appear to be substantially similar to the data of the sixth graph 760, and thus, a correlation, an MSE and a maximum error value between the reference data and the data of the sixth graph 760, are calculated to be very large.

The calculation unit 350 compares at least one of the correlation, the MSE, and the maximum error value calculated in the foregoing process with a second reference value, and in the present embodiment, the correlation, the MSE, and the maximum error value higher than the second reference value may be obtained. Thus, the calculation unit 350 may determine the data of the fourth graph 740 as the sensed data obtained through the operation for removing the foreign object such as droplets of water, or the like, present on the panel unit 310, rather than a normal touch. As a result, the calculation unit 350 may perform only a process of newly updating or correcting the offset value without performing calculation such as determining coordinates of the touch, or the like.

As set forth above, according to embodiments of the invention, valid data from which an offset value is removed is compared with a first reference value, and it is determined whether a touch has been generated according to the comparison results. When the valid data is higher than the first reference value, a relationship between the reference data and the valid data is calculated, and it is determined whether the data has been generated by a touch or by removing a foreign object from the panel unit according to the calculation results, whereby a touch error due to the foreign object of the panel unit can be minimized and a touch can be accurately determined.

While the present invention has been shown and described in connection with the embodiments, it will be apparent to those skilled in the art that modifications and variations can be made without departing from the spirit and scope of the invention as defined by the appended claims.

What is claimed is:

1. A touch sensing method comprising:
obtaining sensed data from a panel unit;
calculating valid data by removing an offset value from the sensed data;
calculating reference data by comparing the offset value with a backup offset value when the valid data is higher than a first reference value; and
determining a touch based on the reference data and the valid data.

2. The touch sensing method of claim 1, wherein the determining of the touch comprises:
calculating a comparison value indicating a relationship between the reference data and the valid data; and
determining the sensed data as being generated by removal of a foreign object in contact with the panel unit when the comparison value is higher than a second reference value, and updating the offset value to a different value.

3. The touch sensing method of claim 2, wherein the determining of the touch comprises calculating at least one of coordinates, number and gesture of the touch based on the valid data when the comparison value is lower than the second reference value.

4. The touch sensing method of claim 2, wherein the calculating of the comparison value comprises using at least one of a correlation, a mean square error (MSE), and a maximum error between the reference data and the valid data as the comparison value.

5. The touch sensing method of claim 1, further comprising updating the offset value when the valid data is lower than the first reference value.

6. The touch sensing method of claim 5, further comprising storing the offset value as the backup offset value before updating the offset value when the valid data has a negative (−) value.

7. The touch sensing method of claim 1, wherein the obtaining of the sensed data is performed based on a change in capacitance generated in a plurality of nodes included in the panel unit.

8. A touch sensing device comprising:
a memory unit;
a valid data calculation unit calculating valid data by subtracting an offset value obtained from the memory unit from sensed data obtained from a panel unit; and
a control unit calculating reference data by comparing the offset value with a predetermined backup offset value when the valid data is higher than a first reference value, and determining a touch based on the reference data and the valid data.

9. The touch sensing device of claim 8, wherein the control unit calculates a comparison value indicating a relationship between the reference data and the valid data, determines the sensed data as being generated by removal of a foreign object in contact with the panel unit when the comparison value is higher than a second reference value, and updates the offset value to a different value.

10. The touch sensing device of claim 9, wherein the control unit determines the touch based on the valid data when the comparison value is lower than the second reference value.

11. The touch sensing device of claim 9, wherein the control unit calculates at least one of a correlation, a mean square error (MSE), and a maximum error between the reference data and the valid data as the comparison value.

12. The touch sensing device of claim 8, wherein the control unit updates the offset value to a different value when the valid data is lower than the first reference value.

13. The touch sensing device of claim 12, wherein the control unit backs up the offset value to the memory unit before updating the offset value when the valid data has a negative (−) value.

14. The touch sensing device of claim 8, further comprising:
a driving circuit unit applying a predetermined driving signal to at least a portion of a plurality of nodes included in the panel unit; and
a sensing circuit unit obtaining the sensed data from the at least a portion of a plurality of nodes to which the driving signal has been applied.

15. A touch sensing device comprising:
a plurality of first electrodes extending in a first axial direction;
a plurality of second electrodes extending in a second axial direction intersecting the first axial direction; and
a controller integrated circuit (IC) detecting changes in capacitance generated between the plurality of first electrodes and the plurality of second electrodes,
wherein the controller IC obtains valid data by subtracting an offset value from sensed data generated by the changes in capacitance, and calculates reference data by comparing the offset value with a backup offset value when the valid data is higher than a first reference value, and
the controller IC determines the sensed data as being generated by removal of a foreign object when a value indicating a relationship between the valid data and the reference data is higher than a predetermined second reference value.

16. The touch sensing device of claim 15, wherein the controller IC determines the touch based on the valid data when the value indicating the relationship between the valid data and the reference data is lower than the second reference value.

17. The touch sensing device of claim 15, wherein the controller IC updates the offset value to a different value when the value indicating the relationship between the valid data and the reference data is higher than the second reference value.
